(19) United States
(12) Patent Application Publication
(10) Pub. No.: US 2005/0247466 A1
(43) Pub. Date: Nov. 10, 2005

(54) Power tool with adjustable hand grip

(76) Inventors: Paolo Andriolo, Vicenza (IT); Michael Panosian, Glendale, CA (US)

Correspondence Address: HEDMAN & COSTIGAN P.C., 1185 AVENUE OF THE AMERICAS, NEW YORK, NY, 10036, US

(21) Appl. No.: 11/106,371

(22) Filed: Apr. 14, 2005

(30) Foreign Application Priority Data
Mar. 11, 2004 (EP) 04075777.5

(51) Int. Cl. B27C 3/08

(52) U.S. Cl. 173/170

(57) ABSTRACT

A power tool (10) with an adjustable hand grip (14), comprising a body housing (11) having, at least in a portion thereof, a curved guide (25) on which a curved element (24) of the hand grip (14) of the power tool (10) can slide, so that the user can modify the angle of the hand grip (14) relative to the working axis (A); the hand grip (14) can be advantageously locked in whichever preferred positions by means of a locking mechanism.

The present invention refers to a power tool and in particular to an adjustable hand grip, comprising a body housing having, at least in a portion thereof, a curved guide on which a curved element of the hand grip of the power tool can slide, so that the user can modify the angle of the hand grip relative to the working axis.

A power tool is normally formed of a housing, a motor, a shaft that drives a tool and a main handle where the power switch is housed.

Said main handle is normally connected to the main housing in a fixed position; such a fixed position of the handle leads to several drawbacks, as described below.

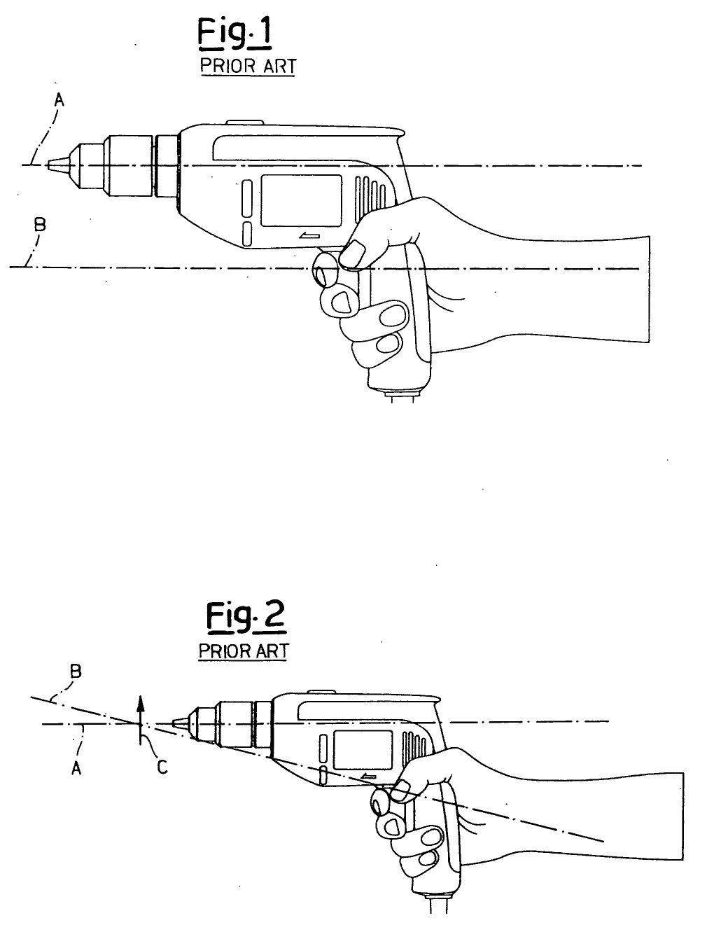

A conventional power drill apparatus is described with reference to FIG. 1.

A power drill generally includes a housing supporting a motor, a gear box and a shaft that drives a tool (e.g. a drill bit).

The main hand grip is normally shaped as a pistol grip that is integrated with the rearward portion of the housing.

One problem with this kind of hand grip is that, as illustrated in FIG. 1, the force of the operator is exploited on the pistol grip along the axis B that is parallel to the axis of rotation (axis A) of the drill bit.

As illustrated in FIG. 2, the result is a torque force C that causes the following disadvantages: part of the operator's force is wasted as shown in FIG. 2, the main housing and all related parts have to bear a torque force that causes stresses on the materials and mechanical joints and can cause a play in the gear housing and in the ball bearings and oil bearings.

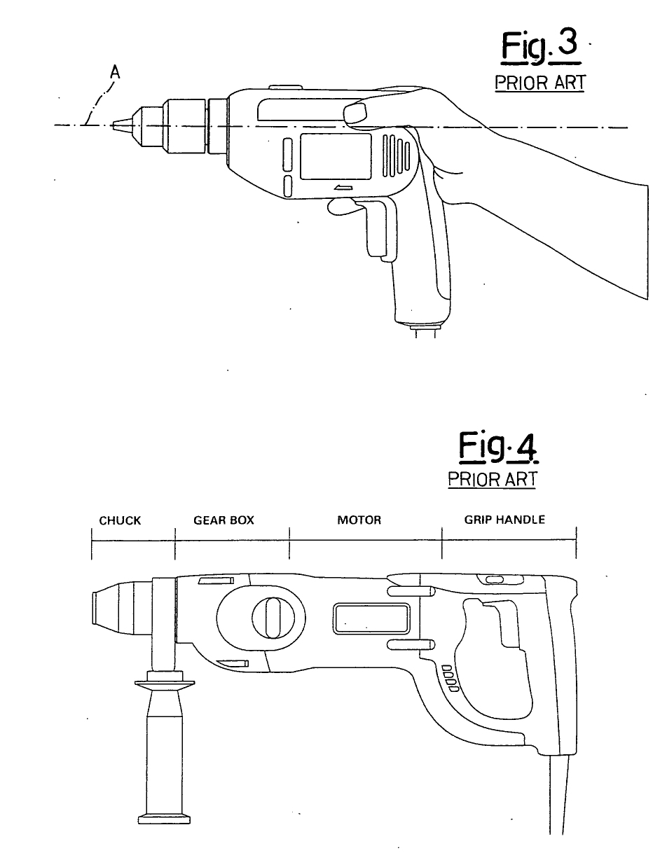

In order to overcome to the above-mentioned drawback, expert users and professionals are used to operate the drill by holding it in an upper position, which makes the force exploitation axis get closer to the bit axis A (see FIG. 3).

However, this practice requires the adoption of a complex, uncomfortable and unsafe sequence of actions: 1) turn the trigger switch on; 2) lock it by means of the lock-on button; 3) move the hand to the upper grip position.

This practice does not allow the operator to conveniently operate the switch.

By locking the switch, the operator cannot take advantage of the variable speed control normally incorporated in trigger switches and, moreover, cannot promptly turn the machine off in case the drill bit gets stalled due to high friction with the working material. The consequence of such an unsafe operation can be severe for the operator.

Another conventional power drill design presents a fixed grip handle that is placed at the rear end of the machine, as illustrated in FIG. 4.

With this solution, the axis along which the operator's force is exploited is closer to the axis of rotation of the drill bit.

However, with this solution the overall length of the machine is substantially increased relative to the conventional pistol grip design.

As a consequence, the machine is not balanced and cannot be conveniently operated without the help of an additional front handle.

Such an unbalanced machine causes an early operator's fatigue, especially when working on overhead positions, therefore forcing the operator to take frequent rests and reduce productivity.

In addition, this configuration of the power tool does not favor accuracy and precision of operation due to the length of the machine itself.

Furthermore, the operation of such a machine could be difficult and even impossible in case of limited operation room and other space restrictions that are common in buildings and constructions.

Another drawback of conventional power tool apparatus is that the grip handle is fixed at a certain position respective to the main body, forming a certain angle with the main tool axis. This does not allow suitable ergonomic postures for the user in different working positions.

Poor ergonomic design in power tool handles is a well-know factor contributing to bio-mechanical stresses on the hand, wrist and elbow, which increases the risk of MSDs (Musculo Skeletal Disorders) and CTDs (Cumulative Trauma Disorders) of workers.

The evidence of major studies on ergonomics is that the best way to prevent MSDs and CTDs is through the respect of the “neutral posture” of the human body.

The neutral posture is a precise condition where there is a status of muscular and articular balance.

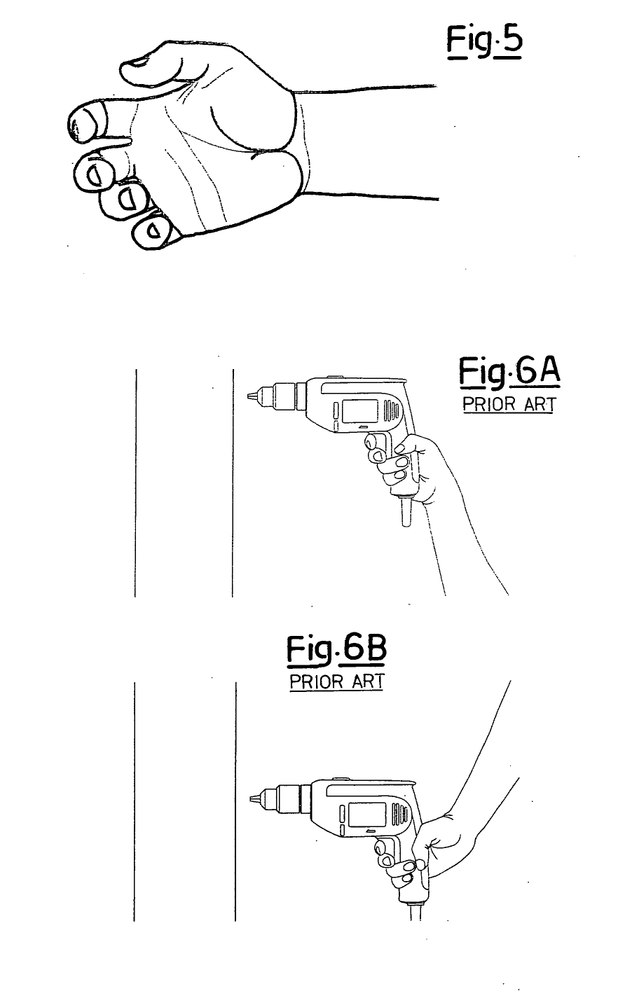

Several electro-miographical studies evidence that the neutral posture of the hand and forearm coincides with the “functional” posture of the hand, as illustrated in FIG. 5, according to which:
1) fingers are slightly flexed on the three articulations, due to the prevalence of flexors over extensors, and flexion gradually increases towards the little finger;
2) thumb is in semi-opposition, metacarpus-phalanx is semi-flexed and inter-phalanx is slightly flexed;
3) wrist is slightly extended, with a slight ulnar inclination.

Fixed hand grips of conventional power tools do not allow the respect of the neutral posture in various working positions, as illustrated in FIGS. 6A-6B.

Fixed hand grips force the operator to assume awkward postures, as those illustrated in FIGS. 6A-6B, such as those where the wrist is hyper-flexed or extended, with the consequence of stretching the underlying tendons and blood vessels over the rigid carpal bones or wrist ligament.

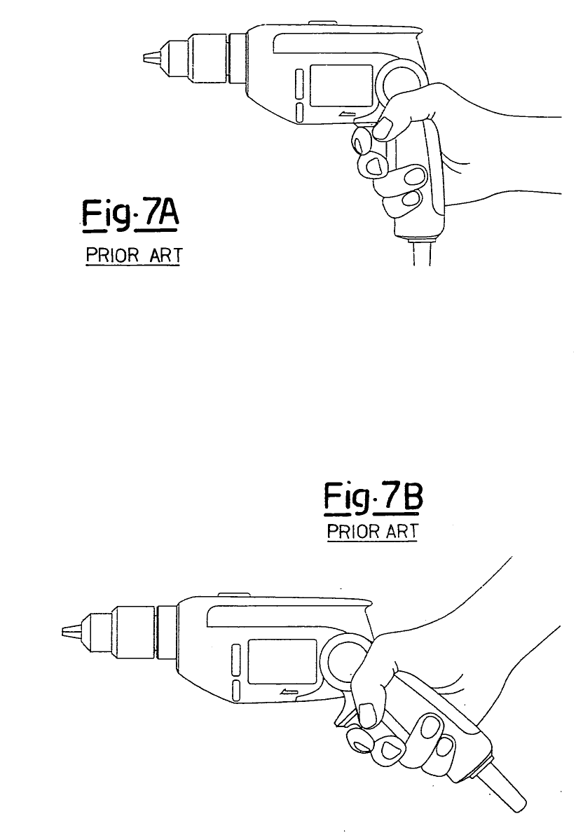

One possible solution for improving the ergonomics of the grip handle of power tools could be that of providing a variety of positions of the hand grip by means of adopting a moving handle whose upper end is connected to the rearward end of the main body by means of a pivoting mechanism, as illustrated in FIGS. 7A-7B and as disclosed in EP-A2-1334789, which however relates to an handle arrangement for a reciprocating saw.

In any case, such a solution would not overcome the above-mentioned problem of making the axis of exploitation of the operator's force closer to the axis of rotation of the drill bit.

Moreover, such a construction method might be quite weak in case of drop of the power tool on the ground. Furthermore, the pivoting joining should be provided with a strong locking mechanism that is designed and engineered for contrasting the operator's force that is applied to the power tool.

In the case of impact drills, hammer drills and in general all power tools with a stroke action, i.e. reciprocating saws, jigsaws, etc., the reaction force of the stroke mechanism would be applied on the locking mechanism itself, which should absorb those high-frequency pulses.

The present invention is intended to eliminate the drawbacks discussed above with respect to the conventional power tools.

A further object of the invention is to provide a power tool with an adjustable hand grip which, with respect to prior art power tools, is extremely reliable and functional for any work need, as well as easy to use. These and other objects of the present invention are achieved by means of a power tool with an adjustable hand grip as claimed in claim 1.

Further implementations are described in the following depending claims.

Advantageously, the invention provides a power tool apparatus which is capable to efficiently transmit the operator's force to the tool by taking the axis along which said force is exploited substantially coincident to the working axis.

Another advantage of the invention is that the operator is allowed to conveniently operate the trigger switch and therefore take advantage of the variable speed control provided, while keeping full control of the switch itself, for improved safety.

A further advantage provided by the invention is that the operator's force is applied to a wide surface rather than on a jointing point, so that the handle can be locked in any preferred position with a simple locking mechanism, for example a cam lock.

The characteristics and advantages of a power tool with an adjustable hand grip according to the present invention will become apparent from the following description, taken by way of non restrictive example, with reference to the further accompanying drawings in which:

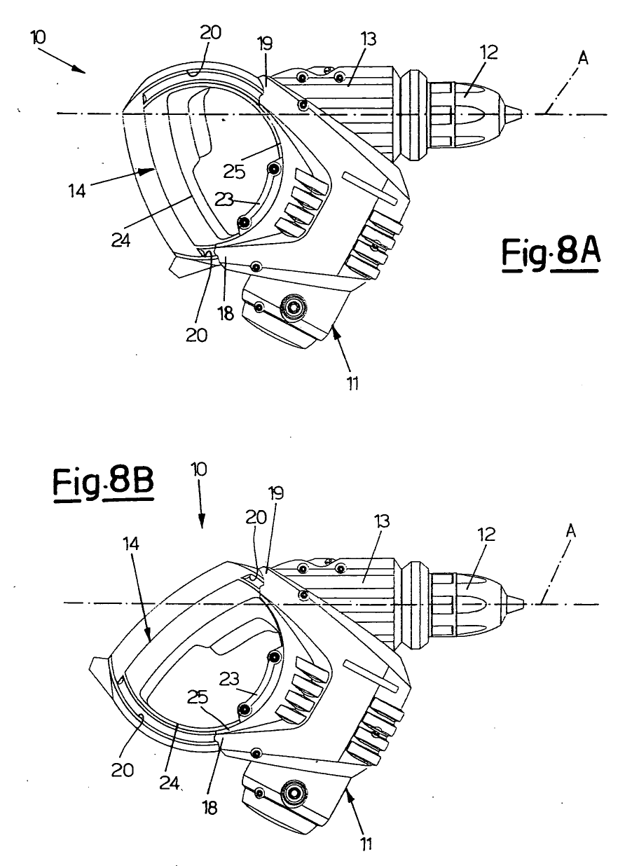

FIGS. 8A and 8B shows two side views of a power tool with an adjustable hand grip, according to the present invention, in two respective working positions of the hand grip;

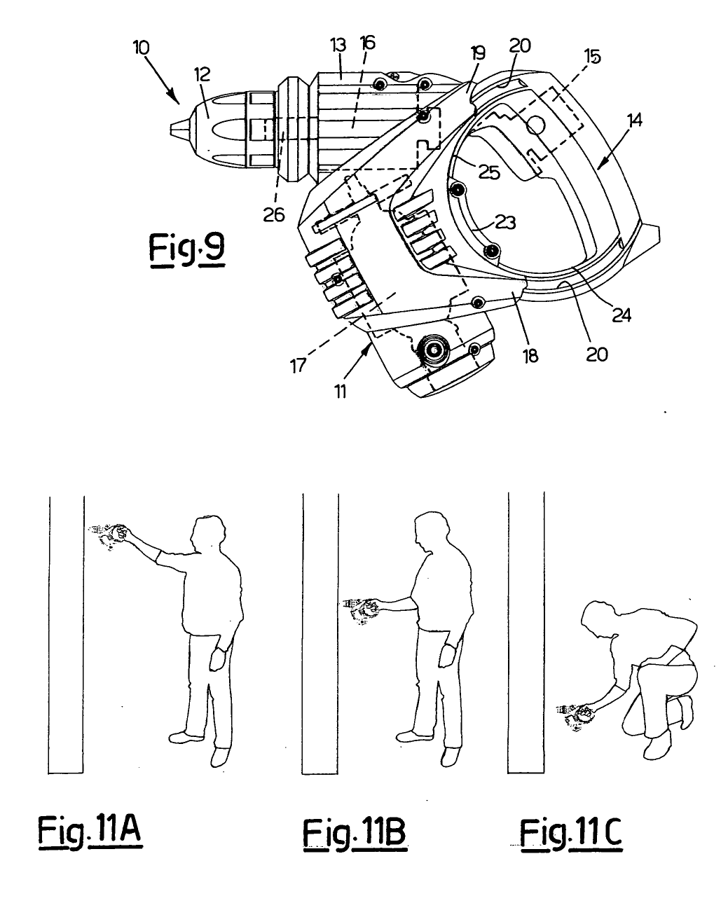

FIG. 9 is a side view of a further embodiment of the power tool with an adjustable hand grip of the present invention;

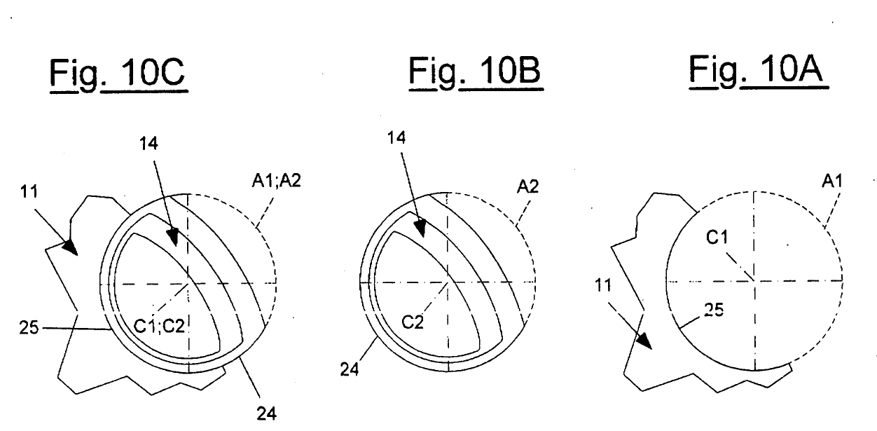

FIGS. 10A, 10B, 10C schematically show three expanded views of details of the power tool according to the present invention;

FIGS. 11A, 11B, 11C schematically show three different working positions of an operator using the power tool of the present invention, and

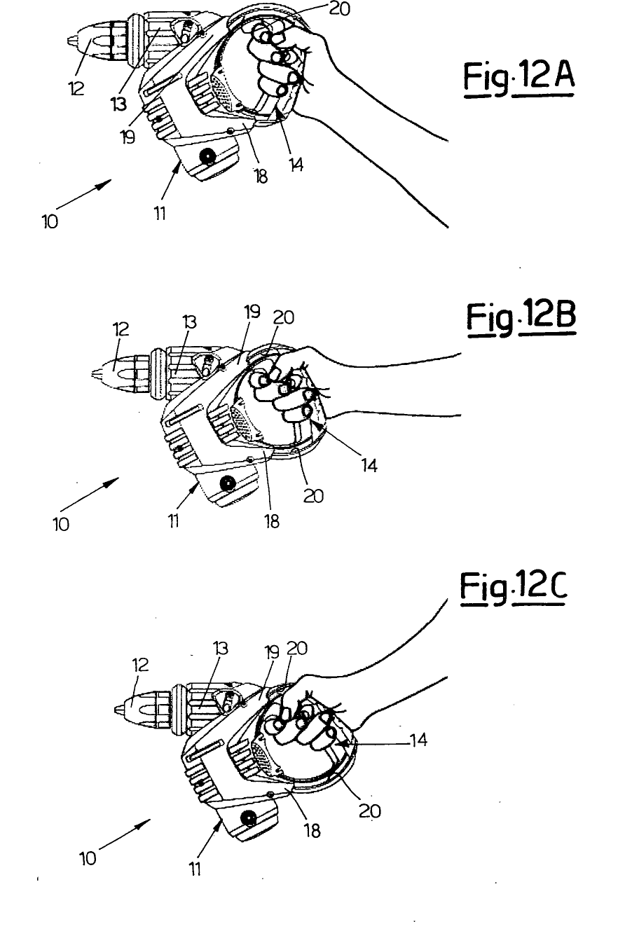

FIGS. 12A, 12B, 12C show three expanded views of details of FIGS. 11A, 11B, 11C, respectively.

With particular reference to FIGS. 8A-8B and 9, a hand-held power tool and, in particular, an electric drill including an adjustable hand grip according to the present invention is generally indicated at 10.

Obviously, even though for ease of illustration the following description refers to an electric drill, the hand grip of the invention can be likewise used, without any modification, with all kinds of power tools.

The electric drill 10 comprises a body housing 11 which contains the main operating electric and mechanical components, a tool holder 12, a shaft 26 that drives the tool, an adjustable hand grip or handle 14 placed inside a recess provided in the containing body housing 11, and, in the case of a cordless apparatus, a specific housing for holding rechargeable batteries.

A transmission unit 16 is positioned inside a gear box 13, whereas a motor 17 and a trigger switch 15 (normally comprising a starting button and a lock-on button) are placed inside the body housing 11.

A further button or locking mechanism 23 is also provided on the hand grip 14 for adjusting the position of the hand grip 14 itself.

The curved element 24 of the hand grip 14, which describes an arc of a circle and matches a curved guide 20 of the body housing 11, which also describes an arc of a circle, as clearly shown in FIGS. 8A-8B, is movable relative to the housing body 11 with a sliding movement up the two terminal portions 18, 19 of the housing 11.

In particular, the fixed curved guide 25 located on the body housing 11 forms a concave curve, while the curved slide 24 of the hand grip 14 forms a convex curve.

In fact, the center C1 of the virtual circle A1 that describes the circular arc of the curved guide 25 lies outside the body housing 11, while the center C2 of the virtual circle A2 that describes the circular arc of the curved slide 24 of the hand grip 14 lies inside the outer edge of the hand grip 14 (FIGS. 10A, 10B).

Furthermore, in a preferred embodiment of the invention, the virtual circle A1 that describes the circular arc of the guide 25 has the same diameter as the virtual circle A2 that describes the circular arc of the curved slide 24 of the hand grip 14 and the center C1 of the virtual circle A1 that describes the circular arc of the guide 25 coincides with the center C2 of the virtual circle A2 that describes the circular arc of the curved slide 24 of the hand grip 14.

In particular, the movement of the hand grip 14 relative to the body housing 11 is a rotation whose center of rotation coincides with the center C1 of the virtual circle A1 that describes the circular arc of the guide 25 and with the center C2 of the virtual circle A2 that describes the circular arc of the curved slide 24 of the hand grip 14 (FIG. 10C).

This peculiar configuration of the hand-held power tool 10 makes the power tool particularly compact, sturdy and easily utilizable for any kind of work and by any user, being either a professional of the field or a person keen on “do-it-yourself”.

In particular, as described in FIGS. 8A and 8B, in each position of the hand grip 14 the force exploited to the machine is substantially on the same working axis A, where the reaction force is concentrated.

This way, the torque force is substantially equal to zero and all the exploited force is transferred to the load, therefore improving the efficiency of the operation.

This advantage is obtained whilst keeping the overall size of the power tool 10 extremely compact, for optimal balance and ease of use.

In particular, in the embodiment as represented in FIG. 9, the adjustable handle 14 is located closer to the gear box 13, while the motor 17 is located along an oblique axis; this way, the distribution of weight is well balanced and allows the user to conveniently and comfortably operate the power tool.

Furthermore, the movable hand grip 14 is advantageously provided with the locking mechanism 23 locking the handle 14 at whichever position according to user's preference and convenience.

The locking mechanism can be engaged and disengaged for sliding and locking the hand grip 14 by means of the button 23, which can be operated to release the hand grip 14 from its original position so that it can be rotated to a new preferred position and locked into this new position.

The possibility of rotating the hand grip 14 allows the operator to adjust the angle of the grip relative to the axis of the tool, in order to achieve the best ergonomic conditions upon working.

In fact, as described in FIGS. 11A, 11B, 11C, 12A, 12B, 12C, the invention allows the operator to select a position that, according to the task and position, is appropriate to an efficient and comfortable operation, by ensuring an ergonomically correct posture.

The whole structure of the body housing 11 is also designed all over again relative to prior art to contain, in a steady position, the mechanical, electric and electronic operating components, such as the electric motor 17 and the transmission system 16.

In this regard, also the electric wires, coming out of the trigger switch 15, are positioned in the hand grip 14 and inside the body housing 11 to follow freely all the admitted adjustment positions which can be taken by the hand grip 14 during the rotation on the curved guide 20 of the housing 11.

The features of the power tool with an adjustable hand grip of the invention become apparent from the above description.

Finally, it is clear that several variations can be made to the power tool of the invention, without departing from the scope of the invention, and that the materials, shapes and dimensions of the illustrated details can vary according to one's needs and be changed with other technically equivalent ones.

1. A power tool (10) with adjustable hand grip (14), comprising a body housing (11), a motor (17), a tool holder (12), a shaft (26) that drives a tool, a power trigger switch (15) that is housed in said hand grip (14), which is connected to the body housing (11), characterized in that said body housing (11) has, at least in a portion thereof, a curved guide (25) on which a curved slide (24) of the hand grip (14) of the power tool (10) can slide, said curved slide (24) matching the curved guide (25) and said curved guide (25) of the body housing (11) and said curved slide (24) of the hand grip (14) forming a sliding mechanism that allows rotation of the hand grip (14) relative to said body housing (11), so that the user can modify the angle of the hand grip (14) relative to the working axis.

2. A power tool (10) with adjustable hand grip (14) as claimed in claim 1, wherein said curved guide (25) of the body housing (11) and said curved slide (24) of the hand grip (14) both describe an arc of circle.

3. A power tool (10) with adjustable hand grip (14) as claimed in claim 1, wherein said guide (25) forms a concave curve and the first center (C1) of a first virtual circle (A1) that describes the circular arc of the curved guide (25) lies outside the body housing (11) .

4. A power tool (10) with adjustable hand grip (14) as claimed in claim 1, wherein said curved slide (24) of the hand grip (14) forms a convex curve and the second center (C2) of a second virtual circle (A2) that describes the circular arc of said curved slide (24) lies inside a secondary housing that includes the hand grip (14).

5. A power tool (10) with adjustable hand grip (14) as claimed in claims 3 and 4, wherein said first virtual circle (A1) that describes the circular arc of the curved guide (25) has the same diameter of said second virtual circle (A2) that describes the circular arc of said curved slide (24).

6. A power tool (10) with adjustable hand grip (14) as claimed in claims 3 and 4, wherein said first center (C1) of said first virtual circle (A1) coincides with said second center (C2) of said second virtual circle (A2).

7. A power tool (10) with adjustable hand grip (14) as claimed in claim 6, wherein the relative movement between said curved guide (25) of the body housing (11) and said curved slide (24) of the hand grip (14) is a rotation whose center of rotation coincides with said first center (C1) of said first virtual circle (A1) and with said second center (C2) of said second virtual circle (A2).

8. A power tool (10) with adjustable hand grip (14) as claimed in claim 1, wherein the hand grip (14) can be rotated relative to the body housing (11) and locked at several different positions by means of a locking mechanism that can be engaged and disengaged.

9. A power tool (10) with adjustable hand grip (14) as claimed in claim 1, wherein said body housing (11) includes a specific compartment for attaching a pack of batteries.
